(19) United States
(12) Patent Application Publication
(10) Pub. No.: US 2001/0032607 A1
(43) Pub. Date: Oct. 25, 2001

(54) V-type multi-cylinder engine for vehicles

(76) Inventors: Yukihiro Kitagawa, Iwata-shi (JP); Yuji Kinoshita, Iwata-shi (JP); Tomotaka Takano, Iwata-shi (JP)

Correspondence Address: ERNEST A. BEUTLER, ATTORNEY AT LAW, 500 NEWPORT CENTER DRIVE, SUITE 945, NEWPORT BEACH, CA, 92660, US

(21) Appl. No.: 09/681,465

(22) Filed: Apr. 9, 2001

(30) Foreign Application Priority Data
Apr. 19, 2000 (JP) 2000-117373

(51) Int. Cl. F01L 1/02; B60K 5/04

(52) U.S. Cl. 123/90.27; 180/297; 123/90.31

(57) ABSTRACT

A number of embodiments of V-type engine particularly adapted for transverse disposition in an engine compartment either at the front or rear of the vehicle. By appropriately staggering the cylinder banks and locating the various accessory drives, it is possible to make the engine more compact than previous engines and thus permits the use of V-type engines of more than 6 cylinders in such engine compartment placement. In addition, the induction system is designed in such a way so as to not only maintain a compact configuration, but also to reduce the number of plenum chambers that are employed and to permit a single plenum chamber that is disposed over the passenger compartment cylinder bank where the hood line is normally the highest. Thus, low hood lines can be maintained.

### BACKGROUND OF INVENTION

This invention relates to a motor vehicle and more particularly to an improved engine configuration for transverse positioning in a motor vehicle.

In many modern motor vehicles, it has become the practice to place the engine transversely in the engine compartment. This is done either with front engine, front wheel drive vehicles or rear engine, rear wheel drive vehicles. By placing the engine in a transverse or “east/west” configuration, it is possible to maintain a shorter hood line and more compact vehicle construction.

However, in the case of such transverse positioning, the number of cylinders of the engine has been practically limited by conventional engine constructions. If an inline engine is employed, transverse engines have been generally limited to no more than four cylinders. With V-type engines, V6 engines seem to be the longest that can be conveniently accommodated.

The reason that the V-type engine generally must use less cylinders in a bank than an inline engine is because of the stagger that is normally employed between the cylinder banks. That is, in order to permit the connecting rods of the pistons of each bank to share a common crankcase journal, the cylinder bores of one bank are staggered or offset with respect to the other bank.

This gives rise to certain problems in accommodating the engine, as may be understood by reference to FIG. 1 wherein a transverse V8 engine constructed in accordance with a first embodiment of the invention is identified generally by the reference numeral 11. The engine 11 is positioned within an engine compartment 12 of an associated vehicle having a pair of spaced part frame rails 13 and 14. The illustrated embodiment indicates a front wheel drive, front engine location with the forward direction indicated by the arrow “F”. A similar condition is also present in rear engine, rear wheel vehicles although the front direction would be reversed in such an arrangement.

As may be seen, the frame rails 13 and 14 generally converge toward the passenger's compartment side of the vehicle, which is disposed immediately adjacent, and to the rear of the engine compartment 12. In the application of the invention to a rear engine, rear wheel drive configuration, the arrow designated the front would be reversed. As may be seen, the convergence of the frame rails 13 and 14 provides a rather severe space restriction particularly at the side of the engine closest to the passenger's compartment.

This problem is particularly aggravated when the engine has a complex structure such as one, which employs single or multiple overhead camshafts per bank of cylinders. The camshaft drive tends to add to the length of the engine and particularly at the lower part of the engine where the camshaft drive is taken off from the engine crankshaft. Also, it is common to drive a number of other accessories from the engine or its output shafts and the positioning of these accessories can provide significant difficulties.

Still referring to FIG. 1 and discussing primarily the problems with the prior art construction, it would be seen that the engine 11 drives a transmission, final drive assembly, indicated generally by the reference numeral 15, and which includes a transfer case and final drive unit 16 that drives a pair of wheel at the end of the vehicle where the engine 11 is located through axle shafts. These axle shafts are normally positioned on the passengers' compartment side of the engine, regardless of front or rear engine location. Hence, the transmission adds significantly to the overall length of the engine in the transverse direction and also adds to the space problem.

In this figure, there are provided a pair of cylinder banks, which comprise the left and right cylinder banks indicated by the reference characters “L” and “R”, respectively. As may be seen, the front cylinder bank, which is the left cylinder bank “L” in this embodiment, is staggered so as to be closer to the transmission final drive assembly 15 than the remaining cylinder bank “R”.

By way of nomenclature, transverse engines are still described in the same fashion as with conventional for/aft (“North/South”) engine configurations. That is, the front of the engine is the end opposite that at which the transmission final drive assembly 15 is located. Hence, the left cylinder bank and right cylinder bank refer to the location of the cylinder banks if the engine where placed in a front to rear (N/S) orientation. This common nomenclature will be utilized herein.

It is, therefore, a principal object to this invention to provide an improved V-type engine construction suitable for use when transversely positioned in a vehicle engine compartment and more particularly to an improved accessory drive arrangement that permits the use of greater number of cylinders than heretofore possible for such applications.

It is a further object to this invention to provide an improved arrangement for a V-type engine for utilization in transverse engine position in a motor vehicle wherein the stagger area between the cylinder banks is utilized to provide an accessory drive so as to permit a more compact assembly.

It is a further object to this invention to provide an improved accessory drive for V-type, overhead cam engine of the type aforenoted and for utilization in the environment as noted, wherein one of the camshafts is utilized to drive an accessory positioned in an area that might otherwise not be utilized.

For example, it is generally the practice to provide a water pump that is driven at the front of the engine and frequently which is driven off of a belt disposed at the front of the engine and adjacent that belt and the camshaft drive. This obviously increases the length of the engine and sacrifices the space utilization.

It is, therefore, a still further object to this invention to provide an improved V-type engine having overhead camshafts wherein an engine accessory is driven off of the camshaft drive at an end of the engine where the space obtained by the staggering of the cylinder banks is available.

The induction system of an engine is also another component, which gives rise to problems in connection with transverse engine placement. This is particularly true where V-type engines are employed and some form of engine induction system tuning is also incorporated.

It is desirable to maintain as low a hood line as possible and also in some instances, a steeply inclined rake to the hood line. The induction system frequently employed utilizes pairs of plenum chambers each positioned over a respective one of the cylinder banks and which serve an induction system for that cylinder bank.

Obviously, this presents a significant problem in connection with the maintenance of a low hood line.

It is, therefore, a further principal object to this invention to provide an improved induction system for a V-type engine that facilitates transverse positioning in the engine compartment and wherein only a single plenum chamber is employed and which is disposed over the cylinder bank closest to the passenger's compartment where the hood line is normally the highest.

In connection with the utilization of only a single plenum chamber, there is a problem in how the plenum chamber draws atmospheric air so as to have equal distribution to all of the cylinders served. Generally, it has been proposed to position the throttle body and air intake device at one end of the engine and generally this is located over the inlet or the front end of the engine which is not particularly desirable in transverse engine positioning as should be readily apparent from FIG. 1.

Therefore, it is a further object to this invention to provide an improved induction system for a V-type engine wherein a single plenum chamber is positioned only over the cylinder bank closest to the engine compartment but which collects air from one end of the engine and delivers to a central location in the plenum chamber.

Another problem with the utilization of only a single plenum chamber over one of the cylinder banks is maintaining equal length runners to the cylinders of both banks. Generally, the cylinder head intake ports are formed in the individual cylinder heads at locations spaced transversely apart across the valley between the cylinder banks. This makes it very difficult to maintain the same length for the intake passages of both cylinder banks.

It is, therefore, a still further object to this invention to provide an improved induction system for a transversely disposed V-type engine wherein equal length runners can be maintained from a plenum chamber that is disposed above only one of the cylinder banks.

### SUMMARY OF INVENTION

The features of this invention are adapted to be embodied in a motor vehicle having an engine compartment at one end of the vehicle and on one side of a passenger's area of the vehicle. The vehicle has a pair of transversely spaced, longitudinally extending frame members at a lower area of the engine compartment. A V-type internal combustion engine is positioned in the engine compartment with a crankshaft journalled for rotation about an axis that extends transversely to the length of the vehicle. The engine has a pair of angularly disposed cylinder banks that define a valley there between. Each of the cylinder banks defines a plurality of cylinder bores. A transmission driven by the engine at one end thereof drives a least a pair of wheels of the vehicle. The cylinder bores of the cylinder banks are staggered.

In accordance with a first feature of the invention, at least one overhead camshaft is journalled in each of the cylinder banks for actuating valves located therein. An accessory drive is provided for driving an engine accessory from the transmission end of the camshaft of one of the cylinder banks.

In accordance with a second feature of the invention, each of the cylinder banks has a plurality of intake ports disposed contiguous to the valley between them. A plenum chamber is disposed over the cylinder bank closest to the passenger's area. A plurality of manifold runners extends from the plenum chamber to the intake ports. An air inlet is disposed over the transmission and an inlet pipe extends from the air inlet to the plenum chamber.

In accordance with a third feature of the invention, each of the cylinder banks has a plurality of intake ports that are disposed contiguous to the valley and the intake ports all have inlet openings that lie in a line.

### BRIEF DESCRIPTION OF DRAWINGS

FIG. 1 is a top plan view of a motor vehicle embodying an internal combustion engine constructed in accordance with a first embodiment of the invention showing a pair of the frame rails of the vehicle and the engine with portions thereof removed or shown in section.

FIG. 2 is a top plan view, in part similar to FIG. 1, and shows a second embodiment of the invention.

FIG. 3 is an enlarged side elevational view showing the engine compartment with the accessory drive at the front of the engine being shown in solid lines and the remainder of the components being shown in phantom.

FIG. 4 is a transverse cross-sectional view taken through the engine illustrated in FIG. 2 through a plan passing through the center of one of the engine cylinder bores.

FIG. 5 is a top plan view, in part similar to FIGS. 1 and 3, but does not show the frame rails of the associated vehicle.

FIG. 6 is a front elevational view of the engine.

FIG. 7 is a longitudinal cross-sectional view of the engine.

FIG. 8 is a rear elevational view of the engine of this embodiment.

### DETAILED DESCRIPTION

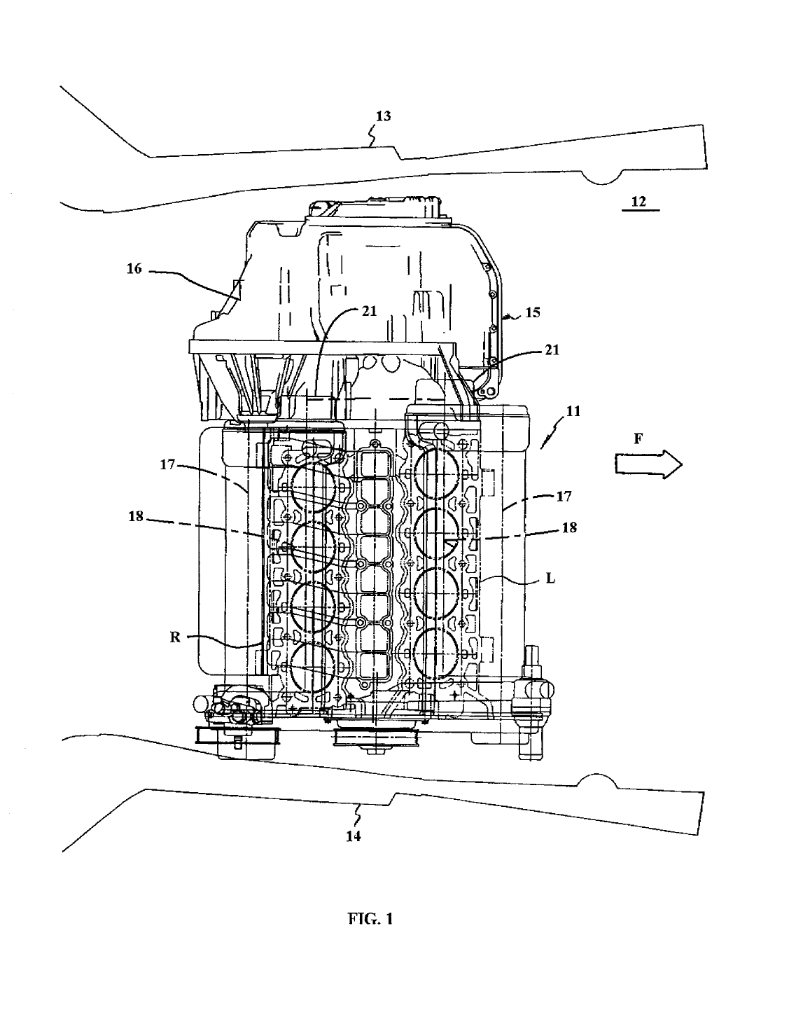

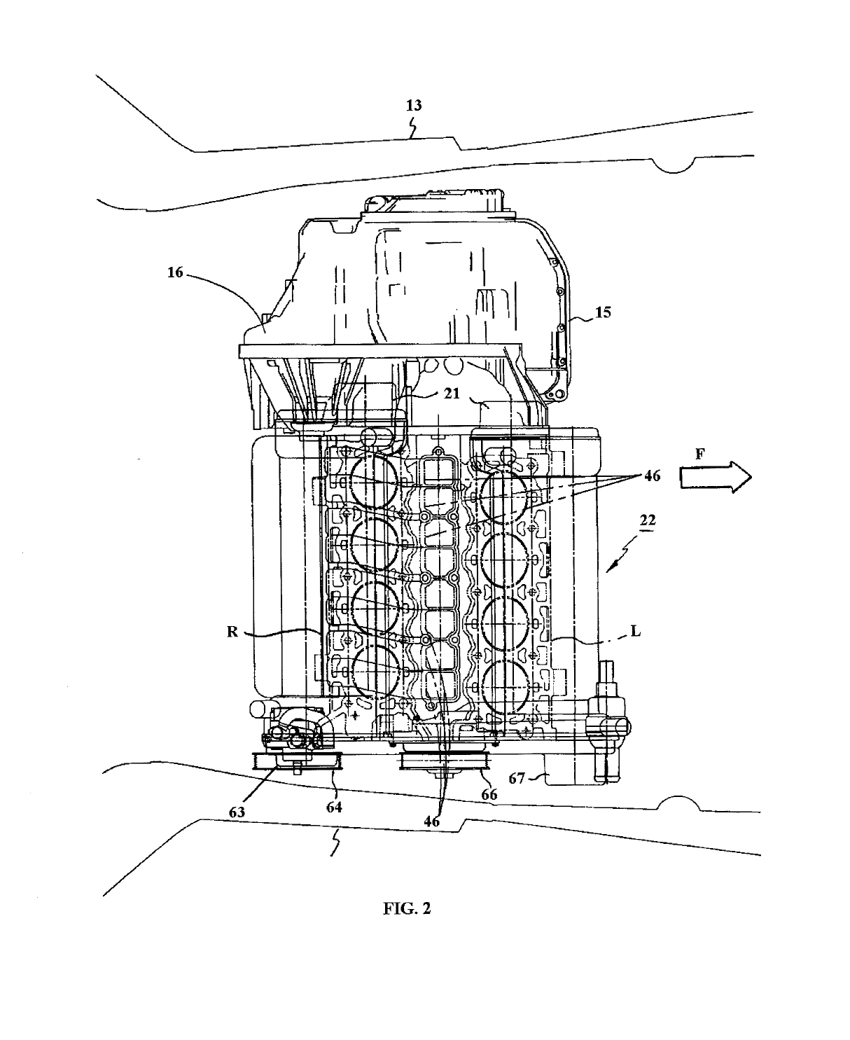

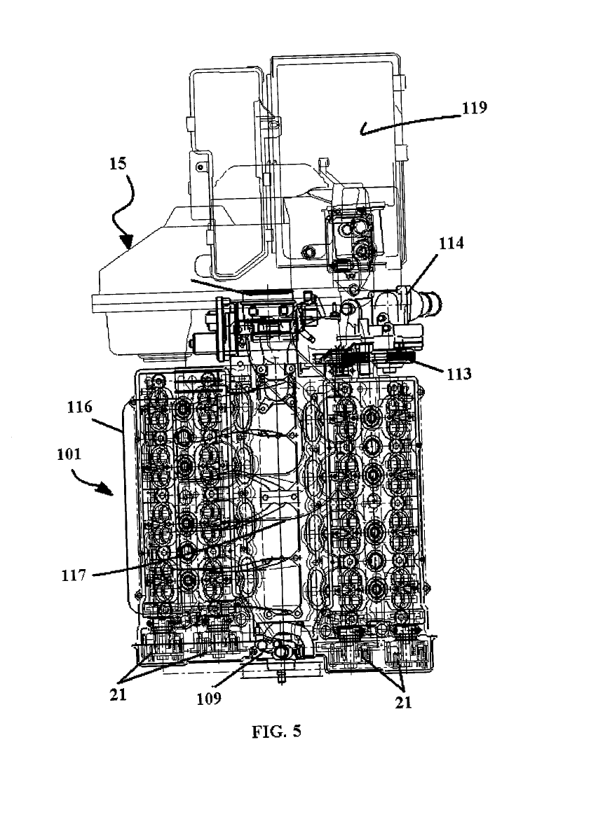

There are three embodiments illustrated comprised of the embodiment of FIG. 1, the embodiment of FIGS. 2 4 and the embodiment of FIGS. 5 8. FIG. 1 has already been partially referred to and the engine in that embodiment is indicated generally by the reference numeral 11 and its left and right cylinder banks have been indicated by the reference characters “L” and “R”, respectively with the transmission indicated by the number 15 and the transfer case for the final drive to the axle shafts being indicated by the reference numeral 16.

In each of the three embodiments, the engine 11 is comprised of a V8, four valves per cylinder arrangement having twin overhead camshafts for each cylinder bank. Although the invention has particular utility with such engines, many of the features disclosed and claimed herein are capable of use with engines having other cylinder numbers and other valve arrangements.

EMBODIMENT OF FIG. 1 In the embodiment of FIG. 1, the four valves per cylinder are not shown but they can have a configuration of the types, which will be hereinafter referred to of the other two embodiments. In this embodiment, however, the cylinder bores, indicated by the reference numeral 17; of each cylinder bank L and R are staggered with respect to each other. In this embodiment the cylinder bank R closest to the passenger's compartment which appears to the left of this figure, is displaced toward the right hand side of the vehicle i.e. adjacent the frame rail 14.

In order to permit a compact construction, with this embodiment the exhaust camshafts and exhaust valves of each cylinder bank, are disposed outwardly of the valley formed between the left and right banks “L” and “R”, on the outer side of each of the cylinder heads. The inlet camshafts and inlet valves are disposed adjacent the valley between the cylinder banks L and R. This valve and camshaft arrangement is used in all of the illustrated embodiments. This embodiment differs from the remaining embodiments that will be described shortly, in the manner in which the intake and exhaust camshafts are driven.

The exhaust camshafts rotate about axes indicated at 18 while the intake camshafts rotate about parallel axes 19. A timing chain or belt at the front of the engine adjacent the frame rail 14 drives the exhaust camshaft of each cylinder bank for rotation about its respective axis 18. This type of cam drive may be of any known type and since the exhaust camshaft is positioned high in the cylinder bank, both at the front and rear of the engine compartment 12, the frame rail 14 will be cleared by this drive.

Variable valve timing mechanisms 21 are associated with each of the intake camshafts on their rotational axes 19 at the rear of the engine on the left hand of the engine compartment 12. These variable valve timing mechanisms 21 may operate in any known manner so as to varying the timing of the intake valves relative to the exhaust valves.

These VVT mechanisms 21 are driven by a chain or belt drives that are disposed at the rear of the engine or on the left had side of the vehicle adjacent the frame rail 13. Since this is the area over the transmission 15 and transfer case 16 it will be clear and hence provides a very compact construction.

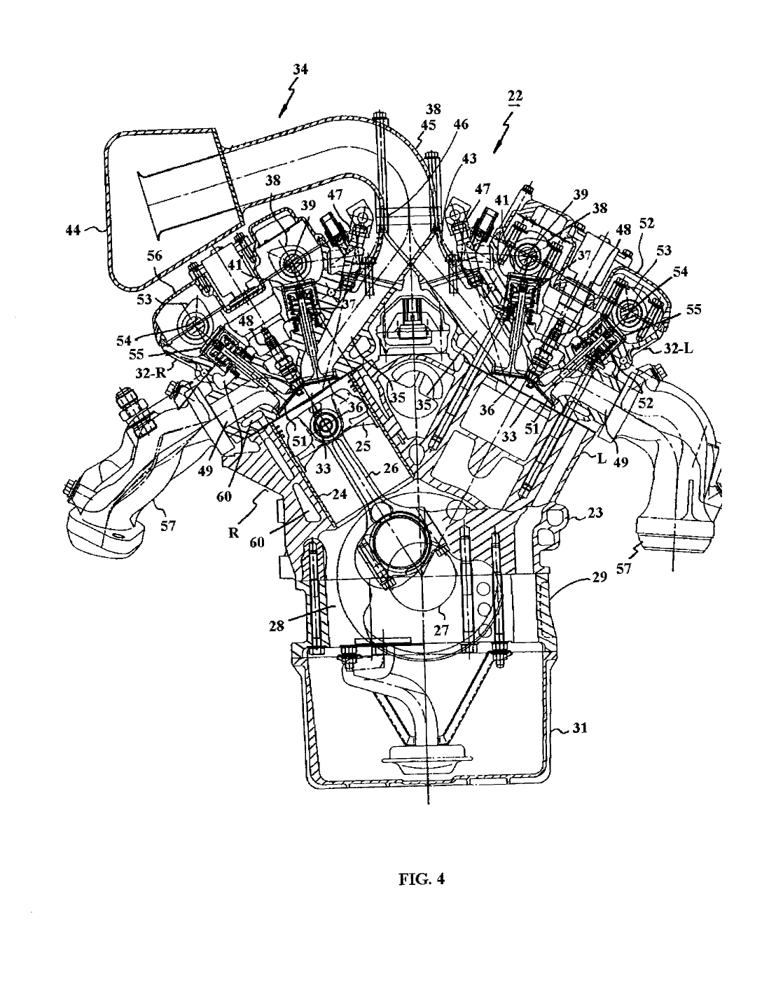

EMBODIMENT OF FIGS. 2-4 Referring now to the embodiment of FIGS. 2-4 and initially primarily to the illustration in FIG. 4, which shows more of the internal details of the engine, indicated generally by the reference numeral 22, of this embodiment, many of which details may be the same as those used with the remaining embodiments. Where that is the case, these embodiments will be identified by the same reference numerals and also the reference numerals applied from FIG. 1 will be employed to identify like components of this and the remaining embodiment.

Therefore, the engine has cylinder banks, indicated at “L” and “R” respectively which are formed in major part by a cylinder block assembly 23 in which cylinder bores 24 are formed. Unlike the preceding embodiment, however, the cylinder bores 24 of the right bank “R” are staggered relative to those of the left bank “L” toward the longitudinal center line of the associated motor vehicle and its engine compartment 12. In other words, the stagger from the front of the engine is greater for the right bank “R” or the bank closest to the passenger's area than the left bank “L”. This provides some further advantages in component layout.

Referring now primarily to FIG. 4, pistons 25 reciprocate within the cylinder bores 24 and are connected to the small ends of connecting rods 26 by means of piston pins. The large ends of the respective connection rods 26 of the cylinder banks L and R are journalled on the throws of a crankshaft 27 in side-by-side fashion in a well known manner. The crankshaft 27 is rotatably journalled within a crankcase chamber 28 formed in major part by a bearing cap 29 that is affixed to the underside of the cylinder block 23 and an oil pan 31 that is affixed thereto.

The ends of the cylinder bores 24 of each bank opposite to the crankcase chamber 28 are closed by respective cylinder head assemblies 32L and 32R, which form a continuation of the respective cylinder banks L and R. These cylinder head assemblies 32L and 32R have recessed surfaces 33 that cooperate with the cylinder bores 24 and the heads of the pistons 25 to form the combustion chambers of the engine.

An induction system, indicated generally by the reference numeral 34 and constructed in accordance with a feature of the invention is provided for delivering an intake charge to intake passages 35 formed on the valley side of the cylinder heads 32L and 32R, respectively. These intake passages 35 terminate in valve seats that are valved by pairs of intake valves 36 for each cylinder.

The intake valves 36 are urged toward their closed position by coil spring assemblies 37 and are opened by the lobes 38 of respective intake camshafts 39 journalled for rotation about the aforenoted intake camshaft axes 19 within the respective cylinder head 32L and 32R in a suitable manner. The cam lobes 38 act on the valves 36 through thimble tappets 41 in a manner well known in this art.

As may be best seen in FIG. 2, a small intake manifold is fixed to the cylinder heads and has a plurality of aligned inlet openings 42. This intake manifold is identified by the reference numeral 43 in FIG. 4 and cooperates with inlet ports formed at the inlet ends of the cylinder head intake passages 35. Because of this inline positioning, it is possible for the induction system 34 which includes the intake manifold 43 to operate with a single plenum chamber 44 disposed only over the rearward most or right hand cylinder bank “R”.

Throttled, silenced and filtered air is admitted to this plenum chamber 44 in a suitable manner. The plenum chamber 44 has four individual runners 45 each of which serve adjacent pairs of the intake passage openings 46 for each bank L and R formed at the termination of the cylinder head intake passages 35 by the intake manifold 43. As a result of this arrangement, it is possible to utilize a single plenum chamber only over the side of the engine closest to the passenger's compartment and where the hood line normally is the highest. Thus, this induction system permits a very compact arrangement. The runner lengths to each cylinder head intake passage 35 can also easily be kept the same.

Fuel injectors 47 are mounted in the cylinder head assemblies 32L and 32R and inject into the intake passages 35 in a direction that intersects the approximate center of the intake ports valved by the intake valves 36. A suitable fuel supply system is provided for delivering fuel to these fuel injectors 47.

Spark plugs 48 are mounted in the cylinder head assemblies 32L and 32R in a generally central location and these spark plugs 48 are fired by a suitable ignition system in accordance with any desired control strategy.

The burnt charge is discharged from the combustion chambers to the engine through exhaust passages 49 formed on the sides of the cylinder head assemblies 32L and 32R opposite to the valley from the intake passages 35. Exhaust valves 51 control the flow of exhaust gases through these exhaust passages 49.

Like the intake valves 36, the exhaust valves 51 are urged to their closed position by coil spring assemblies 52. The exhaust valves 51 are opened by the exhaust lobes 53 of exhaust camshafts 54 working through thimble tappets 55. The exhaust camshafts 54 rotate about the aforenoted exhaust camshaft axes 18. Cam covers 56 close the cylinder head valve actuating chambers and complete the construction of the cylinder heads 32L and 32R.

Exhaust manifolds 57 are affixed to the exhaust sides of the respective banks “L” and “R” and discharge exhaust gases to the atmosphere through a suitable exhaust discharge system.

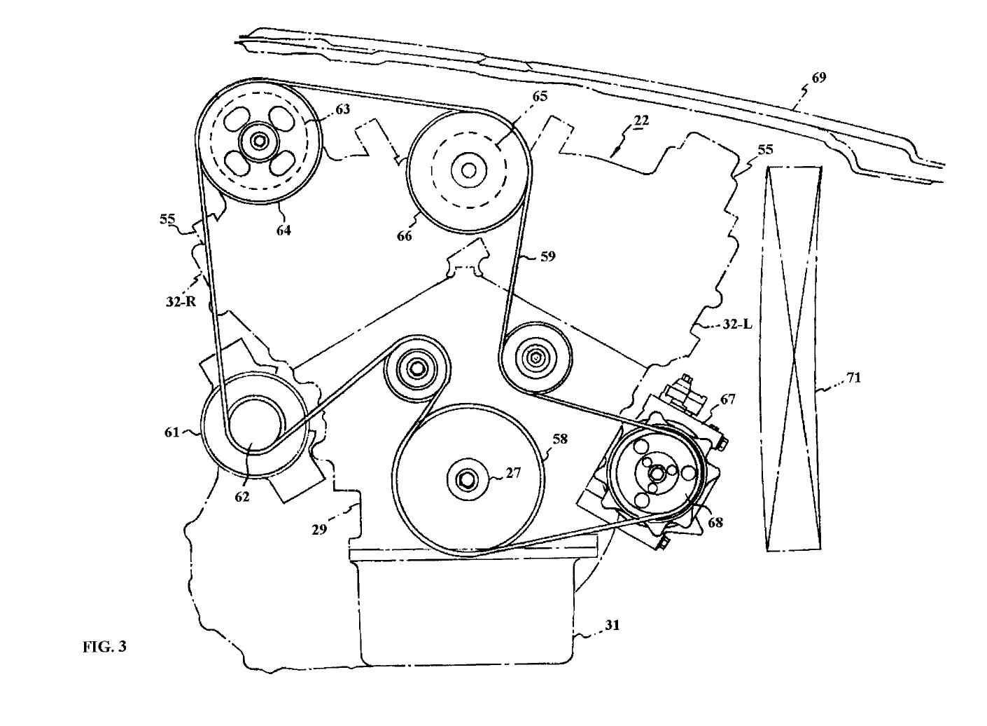

In this embodiment, because of the stagger of the cylinder bank “R” inwardly toward the center of the vehicle, it is possible to utilize more accessory drives at the front of the engine and the accessory drive arrangement, which can be similar to that shown in FIG. 1, will be described by references to FIGS. 2 and 3.

It will be seen that the crankshaft 27 has affixed to its forward end a drive pulley 58 around which a flexible drive belt 59 is entrained. This drive belt 59 can drive a number of accessories such as an alternator 61 having a drive pulley 62 positioned at the rear side of the engine 22 adjacent the passenger's compartment.

Also driven at this end of the engine is a power steering pump 63 that has a drive pulley 64 and which is mounted adjacent the forward end of the exhaust camshaft 54 of this embodiment but not on the same rotational axis as it.

In addition, a water pump 65 has a drive pulley 66 affixed thereto is driven by the belt 59 for circulates cooling water through cylinder block cooling jackets 60 (FIG. 4) and cylinder head cooling jackets identified by the same reference numeral 60.

Also, an air conditioning compressor 67 is driven by the drive belt 59 through a pulley 68, which is mounted, on the front side of the left hand cylinder bank “L”. As a result, it can be seen that the engine 22 permits the use of a low hood line with the hood being shown in phantom and being identified generally by the reference numeral 69 and rearwardly and in close proximity to the heat exchanger or radiator 71 for the engine cooling.

As has been previously noted, the exhaust camshafts 54 of this embodiment are driven off the front of the engine and the intake camshafts off the rear end of the engine through variable valve timing mechanisms 21 as previously identified and referred to in describing the similar arrangement in FIG. 1.

EMBODIMENT OF FIGS. 5-8 FIGS. 5 8 show another embodiment of the invention which, like those previously described, is embodied in a V8, four valve per cylinder twin overhead camshaft engine, indicated generally by the reference numeral 101. The engine 101 has a basic configuration like those previously described. Thus, where components of this engine are the same as those previously described, they will be identified by the same reference numerals and will be described further only to make the construction of this embodiment clear. In addition, the valve operating structure will not be described again and only the differences between the preceding embodiments and this embodiment will be described.

In the figures, the frame rails 13 and 14 are not shown but the engine 101 is adapted to be positioned in an engine compartment having a frame configuration as previously described or of any know type utilized in the art.

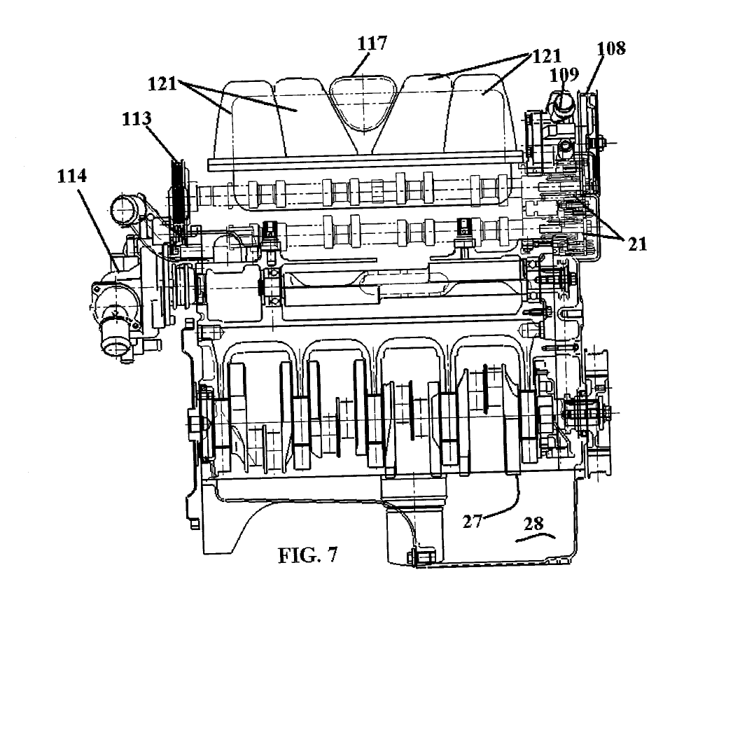

This embodiment is like the embodiment of FIGS. 2 4 in that the right hand cylinder bank R is staggered toward the left hand side of the engine compartment relative to the left hand cylinder bank “L”. Thus, this provides additional space for the accessory drive and specifically, in this embodiment, the drive for the intake and exhaust camshafts 39 and 54. These drives are shown best in FIGS. 5 and 7 and are comprised of variable valve timing mechanisms 21 which are associated with each of the camshafts so that the timing of each camshaft may be varied relative to that of the other of the same bank. This provides greater latitude in the control strategy utilized with the engine. The VVT mechanisms are driven from the crankshaft 27 at the front of the engine 101.

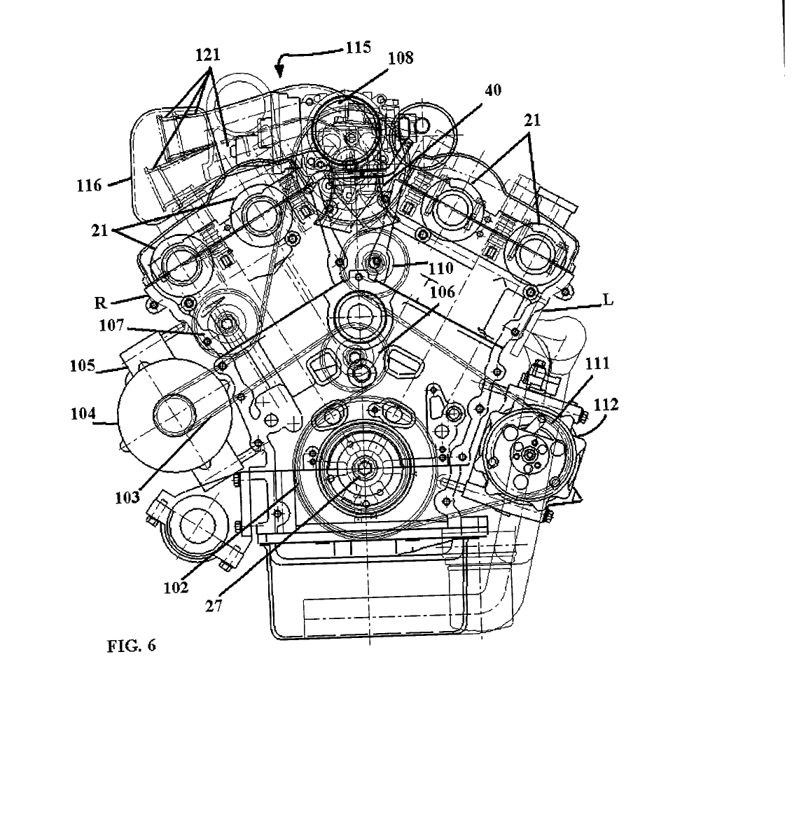

A pulley 102 (FIG. 6) is fixed to the front of the crankshaft 27 forwardly of a timing case that encloses the drive for the intake and exhaust camshafts 37 and 50. A drive belt 103 is driven by this pulley 102 and drives an alternator pulley 104 associated with an alternator 105 mounted on the passenger's compartment side of the engine 101 adjacent the right hand cylinder bank “R”.

This drive belt 103 extends around a pair of idler pulleys 106 and 107 and then drives a pulley 108 that is associated with a power steering pump 109 conveniently mounted at the front of the valley between the cylinder banks R and L and over the timing case cover. This belt 103 then continues on over a further idler pulley 110 to drive the drive pulley 1111 of an air conditioning compressor 112, which is mounted at the front of the engine compartment on the left hand cylinder, bank “L”. Thus, a very compact accessory drive is possible because of the staggering of the cylinder bank “R” toward the transmission end of the engine relative to the cylinder bank “L”.

At the transmission end of the engine 101, the intake camshaft of the left hand cylinder bank “L” drives a drive pulley 112 which, in turn, drives the drive pulley 113 of a water pump assembly 114 that is mounted on the rear end of the left hand cylinder bank in the area where it is staggered relative to the right hand cylinder bank “R”. As a result, further compaction of the overall engine assembly is achieved by this arrangement.

The induction system for this engine is also similar to those of the previously described embodiments. However the induction system, indicated generally by the reference numeral 115, has certain advantages over those other embodiments. In those other embodiments, the intake air for the plenum chamber was disposed at one end of the engine and entered one end of the plenum chamber. In this embodiment, the intake system plenum chamber 116 is located again over the right hand cylinder bank “R”, but it has a curved intake pipe 117 that enters the center of the plenum chamber 116 in the valley area between the cylinder banks R and L. This intake pipe 117 then curves rearwardly to a throttle body 118, which communicates with an elongated intake air silencer and filter arrangement 119 that is disposed above the engine transmission and final drive assembly and rearwardly of the water pump 114.

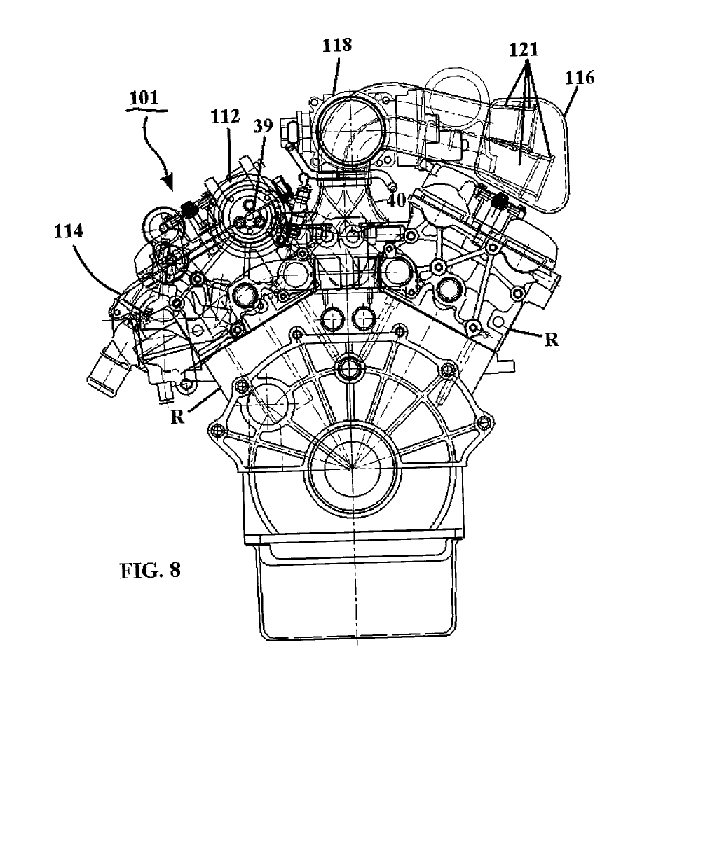

In this embodiment, there are eight individual intake runners 121 which extend from within the plenum chamber 116 to respect ones of the intake ports of the intake manifold 43 which may have a construction as in the previously described embodiments. However, as may be seen in FIGS. 6 and 8, each runner 121 extends at a different length into the plenum chamber 116. This is done to compensate for the difference in length in the runners 121 as they pass to the intake passages 43 of the intake manifold 40 due to the central positioning of the intake pipe 117. Thus, equal lengths are possible and this achieved by varying the degree of extension of the eight intake pipes 121 into the plenum chamber 116.

Thus, from the foregoing description it should be readily apparent that the described embodiments of the invention all provide very compact V-type engines that can be positioned transversely in the engine compartment and which permits the use of more cylinders than heretofore was possible. Although the invention is described in conjunction with V8 engines, it should be understood that the features of the invention can also be used with V-type engines having other cylinder numbers. Other changes and modification may be made without departing from the spirit and scope of invention, as defined by the appended claims.

1. A motor vehicle having an engine compartment at one end of said vehicle and on one side of a passengers' area of said vehicle, said vehicle having a pair of transversely spaced, longitudinally extending frame members at a lower area of said engine compartment, a V-type internal combustion engine positioned in said engine compartment with a crankshaft journalled for rotation about an axis that extends transversely to the length of said vehicle, said engine having a pair of angularly disposed cylinder banks defining a valley therebetween, each of said cylinder banks defining a plurality of cylinder bores, a transmission driven by said engine at one end thereof for driving at least a pair of wheels of said vehicle, the cylinder bores of said cylinder banks being staggered, at least one overhead cam shaft journalled in each of said cylinder banks for actuating valves located therein, and an accessory drive for driving an engine accessory from the transmission end of the cam shaft of one of said cylinder banks.

2. A motor vehicle as set forth in claim 1 wherein the one camshaft is the camshaft of the cylinder bank closest to the passengers' area.

3. A motor vehicle as set forth in claim 3 wherein there are a pair of overhead camshafts journalled in each cylinder bank.

4. A motor vehicle as set forth in claim 3 wherein the accessory driven by the camshaft comprises the other camshaft of the same cylinder bank.

5. A motor vehicle as set forth in claim 3 wherein at least the camshafts of each cylinder bank spaced furthest from the valley are driven from the crankshaft at the end of the engine opposite to the transmission.

6. A motor vehicle as set forth in claim 5 wherein the accessory driven by the cam shaft comprises the other cam shaft of the same cylinder bank and the remaining cam shaft of the other cylinder bank is driven by the other end of the crankshaft driven cam shaft of said other cylinder bank.

7. A motor vehicle as set forth in claim 6 wherein the camshaft driven camshafts of each cylinder bank are driven through a VVT mechanism.

8. A motor vehicle as set forth in claim 7 wherein the WT mechanisms are associated with the camshafts closest to the valley.

9. A motor vehicle as set forth in claim 6 wherein the stagger between the cylinder banks is such that the cylinder bores of the cylinder bank closest to the passengers' area are closer to the transmission than the corresponding cylinder bores of the cylinder bank furthest from said passengers' area.

10. A motor vehicle as set forth in claim 1 wherein the accessory comprises a pump.

11. A motor vehicle as set forth in claim 10 wherein the pump pumps a fluid for engine operation.

12. A motor vehicle as set forth in claim 11 wherein the pumped fluid comprises a coolant for the engine.

13. A motor vehicle as set forth in claim 11 wherein there are a pair of overhead camshafts journalled in each cylinder bank.

14. A motor vehicle as set forth in claim 13 wherein the camshafts are driven from the crankshaft at the end of the engine opposite to the transmission.

15. A motor vehicle as set forth in claim 14 wherein the pump is driven from the camshaft of the cylinder bank closest to the valley.

16. A motor vehicle as set forth in claim 15 wherein the pump has a rotational axis spaced further from the valley than its driving camshaft.

17. A motor vehicle as set forth in claim 1 wherein there are at least three cylinder bores in each cylinder bank.

18. A motor vehicle as set forth in claim 17 wherein there are four cylinder bores in each cylinder bank.

19. A motor vehicle as set forth in claim 1 wherein each of the cylinder banks has a plurality of intake ports disposed contiguous to said valley, and further including a plenum chamber disposed over the cylinder bank closest to the passengers' area, a plurality of manifold runners extending from said chamber to said intake ports, an air inlet and an inlet pipe extending from said air inlet to said plenum chamber.

20. A motor vehicle as set forth in claim 19 wherein the inlet pipe enters the plenum chamber between the ends of the engine.

21. A motor vehicle as set forth in claim 20 wherein the inlet pipe enters the plenum chamber between a pair of the manifold runners.

22. A motor vehicle as set forth in claim 19 wherein there are four cylinder bores in each cylinder bank and there are four manifold runners.

23. A motor vehicle as set forth in claim 22 wherein each manifold runner serves one intake port of each bank.

24. A motor vehicle as set forth in claim 22 wherein the inlet pipe enters the plenum chamber between the center pair of manifold runners.

25. A motor vehicle as set forth in claim 24 wherein the stagger between the cylinder banks is such that the cylinder bores of the cylinder bank closest to the passengers' area are closer to the transmission than the corresponding cylinder bores of the cylinder bank furthest from said passengers' area.

26. A motor vehicle as set forth in claim 25 wherein the air inlet is disposed at the transmission end of the valley.

27. A motor vehicle as set forth in claim 19 wherein the intake ports all have inlet openings lying in a line and served by the manifold runners.

28. A motor vehicle as set forth in claim 21 wherein there are four cylinder bores in each cylinder bank and there are eight manifold runners.

29. A motor vehicle as set forth in claim 28 wherein each manifold runner serves one intake port.

30. A motor vehicle as set forth in claim 29 wherein the inlet pipe enters the plenum chamber between the center pair of manifold runners.

31. A motor vehicle as set forth in claim 28 wherein the intake ports all have inlet openings lying in a line and served by the manifold runners.

32. A motor vehicle as set forth in claim 30 wherein there are four cylinder bores in each cylinder bank and there are eight manifold runners.

33. A motor vehicle as set forth in claim 32 wherein each manifold runner serves one intake port.

34. A motor vehicle as set forth in claim 41 wherein the inlet pipe enters the plenum chamber between the center pair of manifold runners

35. A motor vehicle having an engine compartment at one end of said vehicle and on one side of a passengers' area of said vehicle, said vehicle having a pair of transversely spaced, longitudinally extending frame members at a lower area of said engine compartment, a V-type internal combustion engine positioned in said engine compartment with a crankshaft journalled for rotation about an axis that extends transversely to the length of said vehicle, said engine having a pair of angularly disposed cylinder banks defining a valley therebetween, each of said cylinder banks defining a plurality of cylinder bores, a transmission driven by said engine at one end thereof for driving at least a pair of wheels of said vehicle, the cylinder bores of said cylinder banks being staggered, each of said cylinder banks having a plurality of intake ports disposed contiguous to said valley, a plenum chamber disposed over the cylinder bank closest to said passengers' area, a plurality of manifold runners extending from said plenum chamber to said intake ports, an air inlet and an inlet pipe extending from said air inlet to said plenum chamber.

36. A motor vehicle as set forth in claim 35 wherein the inlet pipe enters the plenum chamber between the ends of the engine.

37. A motor vehicle as set forth in claim 36 wherein the inlet pipe enters the plenum chamber between a pair of the manifold runners.

38. A motor vehicle as set forth in claim 35 wherein there are four cylinder bores in each cylinder bank and there are four manifold runners.

39. A motor vehicle as set forth in claim 38 wherein each manifold runner serves one intake port of each bank.

40. A motor vehicle as set forth in claim 35 wherein the inlet pipe enters the plenum chamber between the center pair of manifold runners.

41. A motor vehicle as set forth in claim 40 wherein the stagger between the cylinder banks is such that the cylinder bores of the cylinder bank closest to the passengers' area are closer to the transmission than the corresponding cylinder bores of the cylinder bank furthest from said passengers' area.

42. A motor vehicle as set forth in claim 41 wherein the air inlet is disposed at the transmission end of the valley.

43. A motor vehicle having an engine compartment at one end of said vehicle and on one side of a passengers' area of said vehicle, said vehicle having a pair of transversely spaced, longitudinally extending frame members at a lower area of said engine compartment, a V-type internal combustion engine positioned in said engine compartment with a crankshaft journalled for rotation about an axis that extends transversely to the length of said vehicle, said engine having a pair of angularly disposed cylinder banks defining a valley therebetween, each of said cylinder banks defining a plurality of cylinder bores, a transmission driven by said engine at one end thereof for driving at least a pair of wheels of said vehicle, the cylinder bores of said cylinder banks being staggered and each of said cylinder banks having a plurality of intake ports disposed contiguous to said valley, said intake ports all having inlet openings lying in a line.

44. A motor vehicle as set forth in claim 43 wherein the stagger of the cylinder banks is such that the cylinder bores of the cylinder bank closest to the passengers” area is closer to said transmission than the corresponding cylinder bores of the other of said cylinder banks.
